(19) United States
(12) Patent Application Publication
(10) Pub. No.: US 2009/0076953 A1
(43) Pub. Date: Mar. 19, 2009

(54) ATM/Debit Expedited Bill Payments

(75) Inventors: Julie Saville, Cardiff by the Sea, CA (US); Nancy Loomis, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/857,138

(22) Filed: Sep. 18, 2007

(51) Int. Cl. G06Q 20/00

(52) U.S. Cl. 705/40

(57) ABSTRACT

Methods and systems for paying a bill over a financial network are provided. Embodiments of the invention include receiving a payment request at an initiator from a consumer. The payment request may be sent to a financial network. Biller routing information for the biller specified in the payment request is determined at the financial network, at the initiator or at a payment processor. The payment request may be sent to a payment processor using biller routing information. A confirmation message may then be sent to the initiator through the financial network. The initiator may then present the approval or denial message directly to the consumer while the consumer is still in the same session with the initiator. The bill may then be settled between the initiator and the payment processor when the financial network receives the confirmation message that includes an approval message.

### BACKGROUND OF THE INVENTION

This disclosure relates in general to bill payment and, but not by way of limitation, to single message bill payment over an electronic fund transfer network amongst other things.

Generally speaking, there are two methods for paying bills online: financial institution online banking and biller direct payments. In financial institution online banking, the financial institution usually debits the consumer's demand deposit account (DDA), such as a checking account, in real-time (less than twenty-four hours), but the credit to the biller is sent via transmission, such as through the automated clearing house (ACH) or with a paper check. Because financial institution online banking uses either the ACH system or a paper check, they do not provide real-time credit to a biller. With biller direct payments, a consumer can go directly to a biller website or third-party location and make a payment. In such a situation, the debit to the consumer may be real-time, for example, using a debit card or cash or delayed, for example, using ACH or a paper check. The biller typically receives payment via a batch transmission from a third-party processor to the biller. Again, the credit to the biller is not real-time.

Neither of the online bill payment methods described above provides real-time debit to the consumer and real-time credit to the biller. Moreover, the current schemes also do not provide assurance to the consumer that the bill was received and accepted by the biller in real-time.

Accordingly, there is a need in the art for improved bill payment schemes.

### BRIEF SUMMARY OF THE INVENTION

Methods and systems are disclosed providing consumers bill payment options over a financial network. Various embodiments of the invention provide for bill payment over an EFT or ATM network that utilizes a single message format, such as, for example, the ISO 8583 format. Various embodiments of the invention provide real-time confirmation of an expedited bill payment between the consumer and the biller.

A method for paying an expedited bill over an EFT network from a consumer to a biller is provided according to one embodiment of the invention. The method includes receiving a request at an initiator by the consumer to pay a bill to the biller. The request may include a payment amount and a biller account number along with other information. The method may also include creating a payment request message at the initiator. The payment request is forwarded to the EFT network. Biller routing information, such as a biller identification number (BIN) may be looked up at the initiator or the EFT network. The payment request is sent to the billers' payment processor using the biller routing information. The payment processor may be associated with one or more billers and settles payments for the billers. The payment processor may send a confirmation message to the initiator through the EFT network. The confirmation message and/or the contents of the confirmation message may then be forwarded to the consumer. Payment between the initiator and the payment processor may be settled when the confirmation message includes an approved response status. Settlement may occur through the EFT network or when utilizing a settlement intermediary, such as an ACH operator.

In one embodiment of the invention, the EFT network reconciles individual payment transactions to the settlement endpoints. For example, the EFT network reconciles payment transactions between the gateway processor or the initiator and the biller processor. The EFT network may then send the financial settlement transaction between the consumer and the initiator via an intermediary network, such as the ACH system for settlement.

Various embodiments of the invention may include variations to the above described methods. For example, the payment request may comprise a single-message format. The initiator may receive payment for the bill The initiator may debit an account held by the consumer. A gateway processor may be utilized between the initiator and the EFT network. The gateway processor may look up the biller routing information. Settling the bill between the initiator and the payment processor may include debiting the payment amount from the initiator and crediting the payment amount to the payment processor.

A system for conducting bill payments from an initiator to a biller is also provided according to another embodiment of the invention. The system includes an initiator, an EFT network and a payment processor. The initiator is configured to receive payment and biller account information from a consumer for a bill payable to the biller, convert biller account information to biller routing information, as defined by the EFT Network, forward a payment request message to an EFT network that includes the biller routing information, payment amount, and consumer information, receive payment confirmation from the EFT network, and send confirmation information to the consumer. The EFT network is coupled with the initiator and the payment processor. The EFT network may be coupled with the initiator through a gateway processor. The EFT network is configured to receive the payment request forwarded by the initiator, determine routing, forward the payment request to a payment processor, receive confirmation information from a payment processor, forward confirmation information to the initiator, and settle payment of the payment amount between the initiator and the payment processor. The payment processor may be associated with one or more billers. The payment processor may receive a payment request from an EFT network and send payment confirmation information to the EFT network.

Various embodiments of the invention may include variations to the above described embodiments. For example, the initiator may comprise a gateway processor. The payment request may comprise a single-message, such as an ISO 8583 message. The confirmation information may included within a single message, such as an ISO 8583 message. The EFT network may be configured to debit the initiator the payment amount and credit the payment processor the payment amount upon receiving confirmation information that includes approval from the payment processor. The initiator may comprise a financial institution or a third party agent location. The period of time between when the initiator receives payment information from the consumer and when the bill is settled may be less than twenty-four hours. The period of time between when the initiator receives payment information from the consumer and when the biller processor sends confirmation information to the consumer may be less than one minute.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1A shows a block diagram of s bill payment financial system according to one embodiment of the invention.

FIG. 1B shows another block diagram of a bill payment financial system according to one embodiment of the invention.

FIG. 2A shows a flowchart of a method for remitting payment for a bill between a consumer and a biller according to one embodiment of the invention.

FIG. 2B shows another flowchart of a method for remitting payment for a bill between a consumer and a biller according to one embodiment of the invention.

FIG. 3 is a flowchart showing the flow of information between components of a bill payment system according to one embodiment of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

In one embodiment, the present disclosure provides for a method of remitting payment of a bill from a consumer to a biller. A consumer may owe a biller a payment amount for goods or services. For example, the bill may be for utility services, a car loan, a mortgage, a credit card, etc. The consumer may pay the bill, for example, online at webpage, at an agent location or at third-party location. The webpage may be hosted by a financial institution, an agent or a third party. At the webpage, the consumer may be asked to authenticate themselves, for example, by entering a personal identification number or a user name and a password. Various other authentication schemes may also be used. At the financial institution webpage, the consumer may choose an account, such as a debit card account, a checking account, a savings account, etc. The consumer may also select a biller from a list of billers to whom they wish to remit payment for a bill. Payment amount, biller information and consumer information may be sent to the biller through a financial network as a payment request. The financial institution may then debit the consumer's account or receive tender for payment of the bill.

The payment request may travel through various computer systems and networks as it travels to the biller. For example, the payment request may be routed through a gateway processor that is coupled to the financial institution. The payment request may also be routed through a financial network, such as, for example, an ATM network and/or an EFT network. The financial network may be coupled with the gateway processor and/or the financial institution. At the financial institution, gateway processor or the financial network, the biller information may be converted to a biller identification number (BIN). The BIN identifies the biller and routing information for payment of bills to the biller. The payment request may be routed to the biller processor according to the BIN.

The biller processor may be associated with a plurality of billers and may provide settlement and bill processing for each of the billers associated with the biller processor. The payment request is received at the biller processor. The biller processor may confirm receipt of the payment or may request confirmation from the biller. In either case, the payment information may be compared with the account and an approval or denial of the payment may be sent back to the consumer through at least the financial network. This confirmation message may include reasons for denying payment to the biller. The confirmation message may be received at the consumer in real-time.

Both the confirmation message and the payment request may comprise a single message format. The single message format may conform to the ISO 8385 standard. With the single-message format, once the payment is accepted, the payment amount is credited to the biller and confirmation is returned to the consumer without requiring multiple messages being sent from the consumer to the biller through the network. This credit may be guaranteed by the financial network, the gateway processor or the financial institution. Accordingly, the consumer receives real-time confirmation that their bill has been accepted and paid, the biller receives a guaranteed funds. The financial network may provide net settlement of funds between the financial institution and/or the gateway processor and the payment processor and/or the biller. Fund settlement may occur using a settlement operator such as an ACH operator. All settlement may be a net settlement between the parties. Despite the funds being settled later in time, the biller receives funds guaranteed by the financial network. Moreover, the consumer is assured that the funds were accepted and payment for the bill was accepted on the date and time of the bill payment.

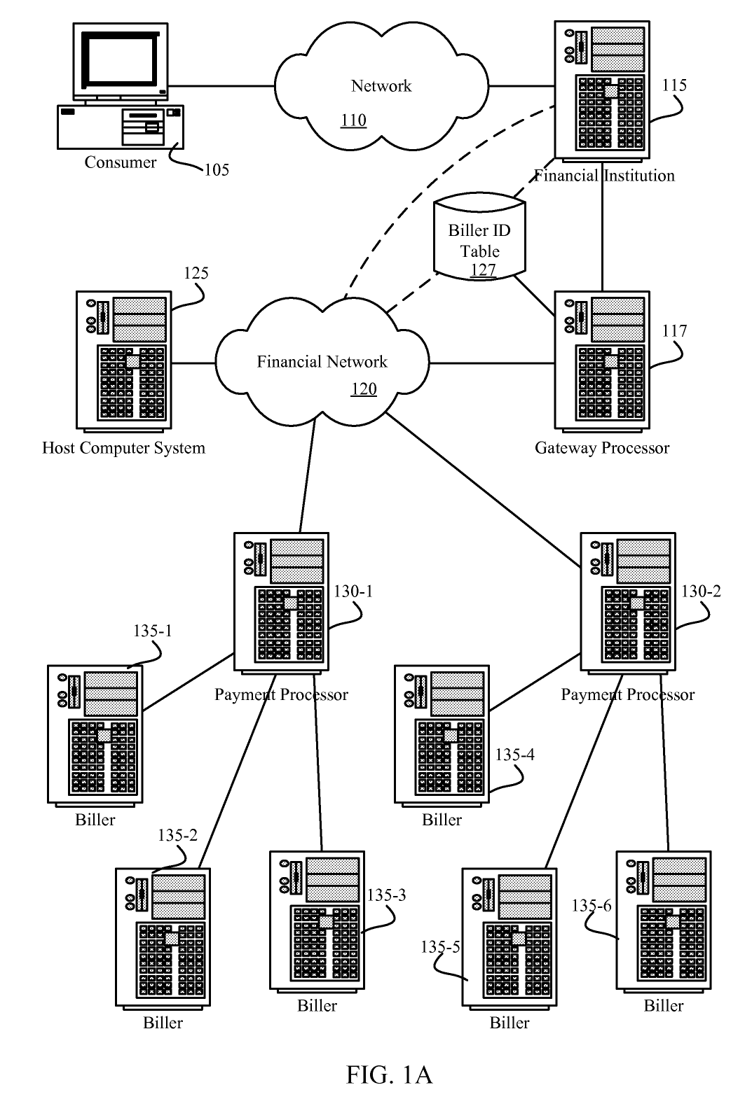

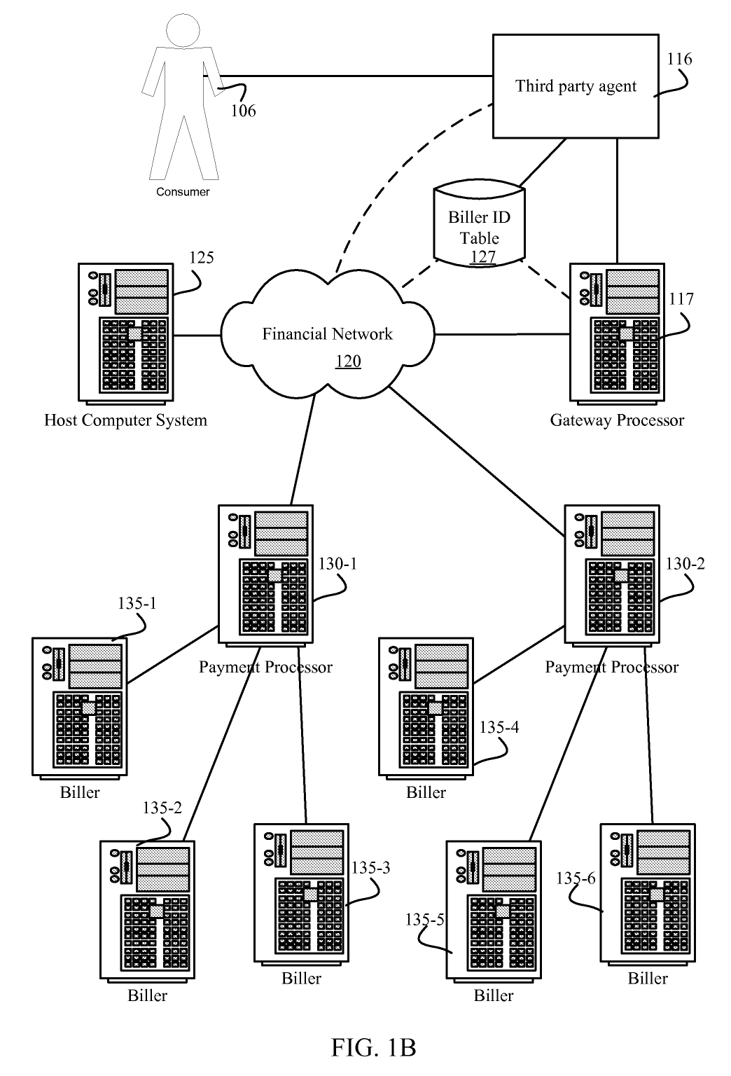

Referring first to FIG. 1A, a block diagram of a system that may be used to remit payments from a consumer to a biller is shown according to one embodiment of the invention. A consumer 105 may access a financial institution 115 through a network 110, such as the Internet. The financial institution 115 may provide a service on a webpage that allows the consumer to pay bills to approved billers. The webpage may require the consumer to authenticate themselves, for example, with PIN and/or a password along with other identifying data. The webpage may also require information about the bill to be paid, including payment amount, biller account number, biller name, bill type, payment date, etc. The consumer may also be required to specify an account from which the funds are to be debited. In some embodiments, the consumer may simply enter a debit card, credit card, or ATM card number along with authentication information. The webpage may be hosted by a third-party on behalf of the financial institution.

The financial institution 115 may be communicatively connected with a gateway processor 117, which is communicatively connected to the financial institution 120 as shown, in one embodiment of the invention. In an alternate embodiment, the financial institution 115 may be communicatively connected to the financial network 120. Financial institution 115 may or may not access the financial network 120 though a gateway processor 117. The connections between the financial institution 115, the gateway processor 117 and the financial network 120 may occur through a network, such as the Internet or a telephone network, or through other systems including direct connectivity. The financial network 120 may include an ATM network, an EFT network, a credit card network, etc. The financial network 120 may include a host computer system 125 that directs and/or manages the financial network 120.

A biller ID table 127 may include information to convert biller information into biller identification number (BIN) that is used to route a payment request to the proper biller processor and/or biller. The biller ID table 127 may be connectively coupled to the financial institution 115, the gateway processor 117 and/or the financial network 120 depending on the embodiment of the invention. The biller ID table 127 may be updated periodically by the financial network 120 or a financial institution. In one embodiment, the biller ID table 127 may include a lookup table corresponding BINs with biller names, biller accounts etc. In another embodiment, the biller ID table 127 may include a relational database or other database that relates billers with BINs.

The financial network 120 is also connected to a plurality of payment processors 130. Two are shown for simplicity. Each payment processor 130 is coupled to at least one biller 135. The biller 135 may include a payment processor 130.

FIG. 1B shows another block diagram of a system that may be used to remit payments from a consumer to a biller according to one embodiment of the invention. Here, a consumer 106 may communicate with a third party agent 116 to pay a bill at a biller. The consumer 106 may communicate with the third party agent in person at an third party agent 116 location, over the phone, via email, or by mail. The third party agent 116 is a party that accepts bill payment that is not associated with the biller 135. For example, a third party agent 116 location may include a financial institution, an ATM, a self-service kiosk, a convenience store, a grocery store, a bank location, a merchant, a call center, an agent bill payment acceptor, such as Western Union®, etc. As shown, the third party agent 116 may be connected directly with a financial network 120 or with a gateway processor 117.

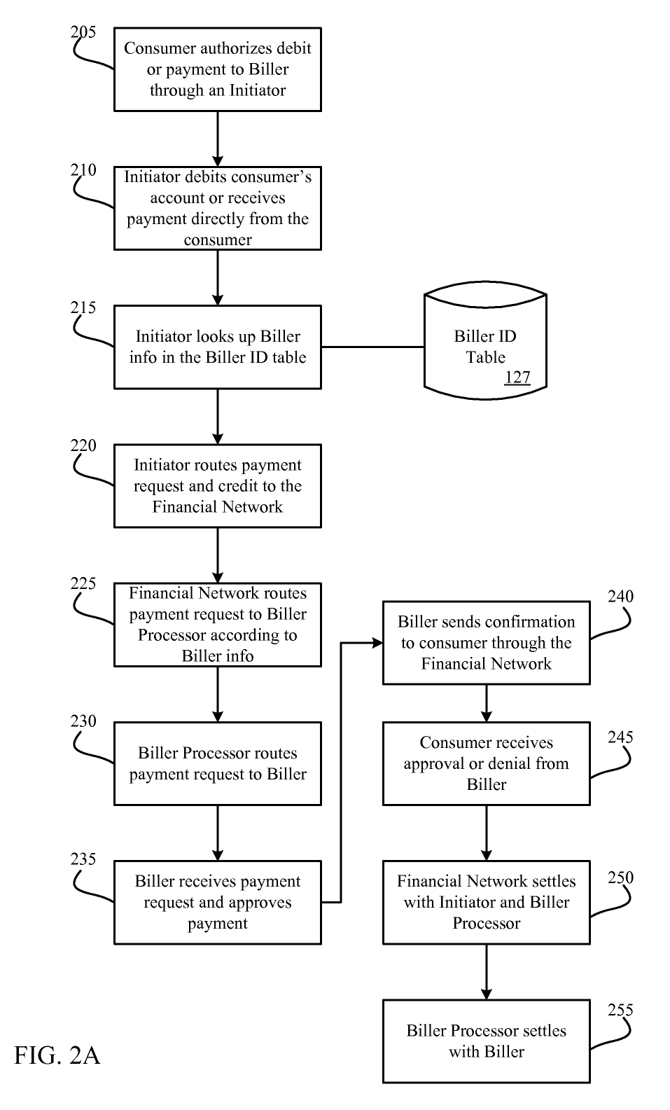

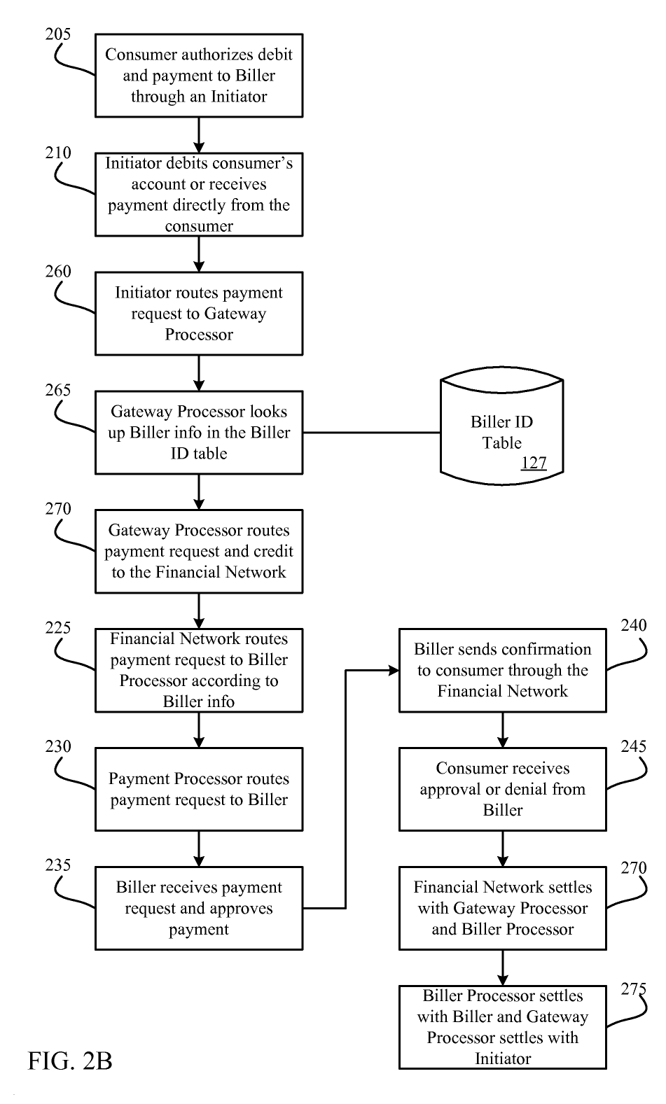

FIG. 2A shows a flowchart of a method for remitting payment for a bill between a consumer and a biller according to one embodiment of the invention. A consumer authorizes a debit from an account or makes a payment through an initiator at block 205, and the initiator, depending on the payment type by the initiator, either debits the consumer's account or receives payment at block 210. An initiator may include a financial institution, a third party agent location, or any entity or location that may accept payment for a bill and pass the payment onto the biller through a financial network. The consumer may make a payment at a financial institution by providing account information and, for example, identification and/or authentication information, such as a PIN, passwords, passcodes, biometrics, identification, etc. The financial institution providing the account may specify the request level of authentication required to make a payment with a specified account. An account may include a debit card account, a checking account, a DDA, a savings account, a prepaid debit card, a credit card account, etc. Alternatively, the consumer may make a payment in person by providing cash, a check, a debit card with PIN, a credit card with signature, etc. The consumer may also provide the biller name, the account number of the bill, biller address, bill date, consumer name, consumer address, a payment amount, etc.

In this embodiment of the invention, the initiator looks up the biller identification number (BIN) in the biller ID table 127 at block 215. The BIN may include information to route a payment request to either the biller processor or the biller. In one embodiment, the BIN only specifies the biller processor. Using the BIN, the initiator may then route a payment request to the financial network at block 220. Routing the payment request may include preparing a message that contains bill payment information to be sent to the biller. In another embodiment of the invention, routing the payment request may include routing the payment request through a gateway processor. In one embodiment, the payment request is in a single message format and permits credit to the biller with a single message. For example, the payment request may include an ISO 8583 message. The payment request may include, for example, the BIN, bill account number, payment amount, consumer identification, date, time, terminal ID, reference number, location of initiator, name of initiator, initiator ID, etc.

The financial network may then route the payment request to the biller processor according to the BIN at block 225. Because the funds were received from the consumer in block 210, the financial network can guarantee payment of the bill to the biller processor. The biller processor receives the payment request and at block 230 the biller processor routes the payment request to the biller whereupon the payment request is received at the biller and payment is approved or denied at block 235. The biller may then send a confirmation message to the consumer back through the financial network at block 240. The confirmation message may include a single message formation and may conform, for example, to the ISO 8583 standard.

In an alternate embodiment of the invention, the biller processor may receive the payment request from the financial network and accept or deny payment requests in behalf of the biller. Accordingly, the payment processor, rather than the biller, may send a confirmation message to the consumer through the financial network in this embodiment of the invention.

The consumer may receive the confirmation message from the biller, or biller processor and from the initiator showing acceptance or denial of the payment, at block 245. If accepted, the confirmation message assures the consumer that they need not concern themselves with the bill. If denied, the confirmation message may include information regarding why the payment was denied. The consumer may resubmit the payment, correcting any erroneous information, or may make a payment in another fashion. The confirmation message may be received by the consumer in real-time. That is, the confirmation message may be received by the initiator in less than five minutes from the time the payment was sent from the initiator. In another embodiment of the invention, the confirmation message may be received by the initiator in less than one minute, two minutes, three minutes, four minutes, ten minutes, fifteen minutes, or twenty minutes from the time the payment was sent from the initiator.

In block 250, the financial network settles debits and credits with the initiator and the biller processor. Settlement with the initiator may alternately occur through settlement with a gateway processor. Settlement may include using a third party settlement operator, for example, an ACH operator. In another embodiment, settlement may occur directly between the financial network, biller processor and the initiator. In yet another embodiment, settlement between the biller processor and the financial network may occur using one settlement scheme, while settlement between the financial network and the initiator may occur using a different settlement scheme. The biller and biller processor may settle credits at block 255.

FIG. 2B shows another flowchart of a method for remitting payment for a bill between a consumer and a biller using a gateway processor according to one embodiment of the invention. According to the embodiment of the invention, a consumer makes a bill payment to an initiator for a bill to a biller at block 205. The initiator collects payment from the consumer for the bill payment at block 210. In this embodiment of the invention, however, the initiator forwards the payment request to a gateway processor at block 260. The gateway processor may then lookup BIN within the biller ID table 127 in block 265. The gateway processor forwards the payment request to the financial network at block 270. Handling of the payment request, at blocks 230, 235, 240, 245, occurs in a manner similar to what was described above in regard to FIG. 2A.

Settlement of the bill payment between the financial network and the consumer occurs through the gateway processor as shown in block 270. The gateway processor may then settle payment with the consumer and/or the initiator at block 275.

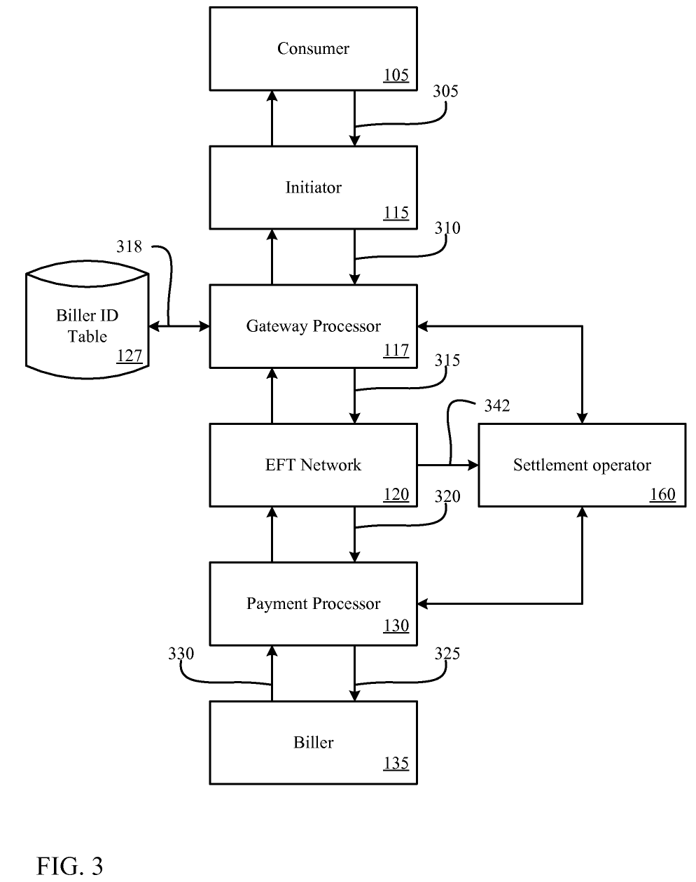

FIG. 3 is a flowchart showing the flow of information between components of a bill payment system according to one embodiment of the invention. The consumer 105 communicates with the initiator 110 over communication path 305. As shown in FIGS. 2A and 2B, the consumer 105 may communicate with the initiator via the Internet or in person. The consumer 105 communicates information that may include biller name, biller account number, biller type, biller address, payment amount, payment type, consumer name, consumer address, etc. In one embodiment of the invention, the consumer 105 may select biller information from a dropdown menu at a webpage.

The initiator 115 communicates with a gateway processor 117 over communication path 310. The initiator 115 may make a payment request with the gateway processor 117 over communication path 310. The payment request may include the biller's name, the consumer's account number at the biller, biller type, biller address, payment amount, initiator type, initiator routing number, initiator location, payment type, consumer name, consumer address, etc. Communication between the initiator 115 and the gateway processor 117 may use a single message format and may, for example, be an ISO 8583 message.

The gateway processor 117 may communicate with a biller ID table 127. The biller ID table may be included at the gateway processor 117 or elsewhere and accessed through a network. The gateway processor 117 may send biller information to the biller ID table 127 over communication channel 318 and receive a BIN for the biller in return. The gateway processor 117 may then route the payment request to the EFT network 120 using the BIN over communication channel 315.

In other embodiments of the invention, the Initiator 115 may communicate directly with the EFT network 120. In yet another embodiment of the invention, the initiator 115 may access the biller ID table and convert the biller information received from the consumer 105 into a BIN.

The EFT network 120, using the BIN, routes the payment request to the payment processor 130 over communication path 320. The payment processor 130 may then accept or deny the payment or send a message to the biller 135 over path 325 querying whether to accept or deny the payment. The payment processor 130 may receive acceptance or denial information from the biller 135 over path 330. The payment processor 130 and biller 135 may use any means to communicate over paths 325, 330. A confirmation message containing acceptance or denial information may then be sent back to the consumer 105 through the EFT network 120, gateway processor 117, and the initiator 115. The confirmation message may utilize a single-message format, such as, for example, following the ISO 8583 format. In another embodiment of the invention, the payment processor 130 may make the acceptance/denial decision without real-time input from the biller 135.

Settlement of the payment may be initiated by the EFT network 120 when a confirmation message is sent through the EFT network 120 that accepts the payment. A settlement message may be generated by the EFT network 120 that is sent over communication path 342 to a settlement operator 160. The settlement message may, for example, be an ACH message. The settlement operator 160 may debit the gateway processor 117 the payment amount and credit the payment processor 130 the payment amount. The payment amount debited and credited may include an additional fee by the gateway processor 117, the EFT network 120, the settlement operator 160 and/or the payment processor 130. Settlement may occur within less than twelve hours, less than eighteen hours, less than thirty hours, less than twenty four hours or less than thirty six hours.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for paying a bill over an EFT network from a consumer to a biller, the method comprising:
receiving a request to pay a bill to the biller at an initiator from the consumer, wherein the request includes a payment amount and a biller account number;
creating a payment request message at the initiator;
sending the payment request to the EFT network;
looking up biller routing information for the biller specified in the payment request;
sending the payment request to a payment processor using the biller routing information, wherein the payment processor is associated with one or more billers and the payment processor settles payments for the billers;
sending a payment confirmation message to the initiator through the EFT network; and
settling payment of the bill between the initiator and the payment processor when the EFT network receives the confirmation message that includes an approval message.

2. The method according to claim 1, wherein the payment request comprises a single-message format.

3. The method according to claim 1, wherein the initiator receives payment for the bill.

4. The method according to claim 1, wherein sending the payment request to the EFT network includes sending the payment request to the EFT network through a gateway processor.

5. The method according to claim 1, wherein the looking up biller routing information occurs at the EFT network.

6. The method according to claim 1, wherein the looking up biller routing information occurs at the initiator.

7. The method according to claim 1, wherein the initiator sends payment confirmation information to the consumer upon receiving the payment confirmation message.

8. The method according to claim 1, wherein the payment confirmation message is created and sent to the initiator through the EFT network by the payment processor.

9. The method according to claim 1, wherein settling payment of the bill between the initiator and the payment processor includes debiting the payment amount from the initiator and crediting the payment amount to the payment processor.

10. The method according to claim 1, wherein settling payment of the bill between the initiator and the payment processor includes debiting the payment amount from a gateway processor and crediting the payment amount to the payment processor.

11. A system for conducting bill payments from an initiator to a biller, the system comprising:
an initiator configured to:
receive payment and biller account information from a consumer for a bill payable to the biller,
convert biller account information to biller routing information,
forward a payment request message to an EFT network that includes the biller routing information, payment amount, and consumer information,
receive payment confirmation from the EFT network, and
send confirmation information to the consumer;
an EFT network coupled with the initiator configured to:
receive the payment request forwarded by the initiator,
forward the payment request to a payment processor according to the biller routing information;
receive confirmation information from a payment processor,
forward confirmation information to the initiator, and
settle payment of the bill between the initiator and the payment processor;
a payment processor coupled with the EFT network and associated with one or more billers configured to:
receive a payment request from an EFT network, and
send payment confirmation information to the EFT network.

12. The system according to claim 11, wherein the initiator comprises a gateway processor.

13. The system according to claim 11, wherein the payment request comprises a single-message.

14. The system according to claim 11, wherein the payment request comprises an ISO 8583 message.

15. The system according to claim 11, wherein the confirmation information comprises a single-message.

16. The system according to claim 11, wherein the confirmation information comprises an ISO 8583 message.

17. The system according to claim 11, wherein the EFT network is configured to debit the initiator the payment amount and credit the payment processor the payment amount upon receiving confirmation information that includes approval from the payment processor.

18. The system according to claim 11, wherein the initiator comprises a financial institution.

19. The system according to claim 11, wherein the period of time between when the initiator receives payment information from the consumer and when the bill is settled is less than twenty-four hours.

20. The system according to claim 11, wherein the period of time between when the initiator receives payment information from the consumer and when the initiator sends confirmation information to the consumer is less than one minute.
